(19) United States
(12) Patent Application Publication
(10) Pub. No.: US 2025/0056330 A1
(43) Pub. Date: Feb. 13, 2025

(54) METHOD AND APPARATUS FOR PROACTIVE COMMUNICATION OF RESOURCE MAPPINGS TO NETWORK ELEMENT IMPLEMENTATIONS FOR PERFORMING A TASK

(71) Applicant: Nokia Technologies Oy, Espoo (FI)

(72) Inventors: Diomidis MICHALOPOULOS, Munich (DE); Prajwal KESHAVAMURTHY, Munich (DE); Taylan SAHIN, Munich (DE); Jerediah FEVOLD, Chicago, IL (US)

(21) Appl. No.: 18/795,600

(22) Filed: Aug. 6, 2024

Related U.S. Application Data
(60) Provisional application No. 63/518,604, filed on Aug. 10, 2023.

(51) Int. Cl. H04W 28/24; H04W 48/16

(52) U.S. Cl. CPC H04W 28/24; H04W 48/16

(57) ABSTRACT

A network element receives, from a network node of a wireless communications system, information indicative of an association between a plurality of implementations for a network element of the wireless communications system to perform a respective task and required allocations of resources for the network element to perform the respective task in accordance with one or more respective implementations of the plurality. The network element selects a first implementation of the plurality of implementations to perform the respective task based on available resources for the network element to perform the respective task relative to the required allocation of resources to perform the respective task in accordance with the first implementation. The network element performs the respective task in accordance with the first implementation. The network element causes transmission, to the network node, of information indicative of the first implementation selected to perform the respective task.

### CROSS-REFERENCE TO RELATED APPLICATIONS

This application claims priority to U.S. Provisional Patent Application No. 63/518,604, filed Aug. 10, 2023, the disclosure of this application is expressly incorporated herein by reference in its entirety.

### TECHNOLOGICAL FIELD

An example embodiment relates generally to wireless communications and, more particularly, but not exclusively, to a method, apparatus and computer program product for proactive communication of resource mappings to network element implementations for performing a task.

### BACKGROUND

Some wireless communications systems may include communication devices configured to perform various tasks that utilize artificial intelligence (e.g., machine learning or any other type of artificial intelligence). For example, a communication device, such as a user equipment (UE) may be configured to utilize one or more machine learning models for one or more channel state information (CSI) processes, such as a CSI determination process. In such cases, a UE may utilize the machine learning model to predict CSI for one or more channels, which may enhance one or more operations performed by the UE. In addition to machine-learning-assisted CSI processes, a communication device may utilize one or more artificial intelligence models for beam management, for positioning, or for any other type of task performed by the communication device. However, utilizing artificial models for various tasks at a communication device may consume more resources than if the communication device performed the same task without reliance upon artificial intelligence. Additionally, some communication devices may indiscriminately utilize artificial intelligence models without consideration of available resources, which may result in reduced performance at the communication device.

### BRIEF SUMMARY

In accordance with one or more aspects of the present disclosure, a communication device may be configured (e.g., proactively), with a mapping table that links (e.g., associates, pairs) respective implementations (e.g., configurations, operations, features, functionalities, models, model parameters) for performing one or more tasks with corresponding conditions of the communication device (e.g., resource conditions, required allocations of resources). The communication device may then select an implementation corresponding to a current condition of the communication device, which may improve resource utilization and performance of the communication device.

As an illustrative example, a mapping table may include one entry that indicates an available resource range of 20% to 30% is required for a corresponding first implementation of a task and another entry that indicates an available resource range of 50% or more is required for a corresponding second implementation of the same task. The first implementation may include performing a task (e.g., a positioning operation, a beam management operation, a channel state information (CSI) operation, or the like) without using artificial intelligence or using an artificial intelligence model with a given resource demand (e.g., a relatively low resource demand), while the second implementation may include performing the same task using an artificial intelligence model with a significantly greater resource demand. Accordingly, the communication device may select an implementation using the mapping table that corresponds to the resource availability at the given time. For example, the communication device may select an implementation from the mapping table corresponding to a current condition (e.g., current resource utilization) of the communication device. The communication device may then perform a task (e.g., a positioning operation) in accordance with the implementation selected by the communication device. More specifically, the implementation may specify whether to utilize artificial intelligence for performing the task. Additionally, or alternatively, the implementation may specify one or more parameters for performing the task or one or more models (e.g., artificial intelligence models) for performing the task. As described in further detail herein, such techniques may enable a communication device to more effectively and efficiently utilize or refrain from utilizing artificial intelligence for various tasks and communications based on the available resources of the communication device, which may improve performance of the communication device.

A method for performing the techniques described herein is provided. The method may include receiving, from a network node of a wireless communications system, information indicative of an association between (i) a plurality of implementations for a network element of the wireless communications system to perform a respective task and (ii) required allocations of resources for the network element to perform the respective task in accordance with one or more respective implementations of the plurality of implementations, selecting a first implementation of the plurality of implementations to perform the respective task based at least in part on available resources for the network element to perform the respective task relative to the required allocation of resources to perform the respective task in accordance with the first implementation, and performing the respective task in accordance with the first implementation.

The method further includes causing transmission, to the network node, of information indicative of the first implementation selected to perform the respective task. In some cases, the plurality of implementations correspond to one or more of: one or more implementations for the network element associated with respective artificial intelligence or machine learning enabled features or feature groups, one or more implementations for the network element associated with respective artificial intelligence or machine learning enabled functionalities, or one or more implementation variants for the network element associated with a given artificial intelligence or machine learning enabled functionality.

In some cases, the plurality of implementations comprise one or more implementations for performing the respective task relying on artificial intelligence or machine learning. In some cases, the plurality of implementations comprise one or more implementations for performing the respective task that do not rely on artificial intelligence or machine learning. In some cases, selecting the first implementation out of the plurality of implementations is based at least in part on priorities associated with respective implementations of the plurality of implementations.

The method of an example embodiment further includes causing transmission, to the network node, of resource availability information, where the plurality of implementations are based at least in part on the resource availability information. In some cases, two or more implementations of the plurality of implementations are associated with different types of artificial intelligence or machine learning models. In some cases, the resource availability information includes one or more of: availability information of processing resources for the network element, availability information of memory resources for the network element, battery life information of the network element, availability information of one or more inputs to use for performing the respective task, availability information of one or more outputs to use for the respective task, a connection status of the network element with the wireless communications system, or a connection quality of the network clement with the wireless communications system. In some cases, the resource availability information may include, in addition to other examples of resource availability information described herein (e.g., physical resources at the network element for performing the task), availability information for resources (e.g., communication resources) that are allocated by another network entity to the network entity performing the respective task. As an example, if the network entity is a device performing a positioning task, the resource availability information may include a quantity of positioning reference signals and/or a quantity of transmission/reception points that are detected at the network entity. In such cases, “detection” may occur if received power for positioning reference signals from transmission/reception points satisfies (e.g., is above) a specified threshold. The threshold may be specified for time and frequency resources allocated to the detected positioning reference signals.

In some cases, the resource availability information indicates whether the resource availability information is dynamic or static, where dynamic resource availability information is valid for a limited time duration. In some cases, the level of dynamic resource availability can involve multiple levels of dynamicity, such that the availability of resources can range from being fully static (i.e., no dynamicity) to being fully dynamic (i.e., to vary in the lowest level of time unit), or any dynamicity level in between. In some cases, the resource availability information is indicative of one or more of: a geographic area in which one or more resources for the network element are available, and outside of which the one or more resources for the network element are unavailable, or a period of time during which the one or more resources for the network element are available, and outside of which the one or more resources for the network element are unavailable.

In some cases, the resource availability information is indicative of one of: a percentage of resources that are available with respect to a total quantity of respective resources for the network element, a percentage of resources that are available with respect to a threshold quantity of the respective resources for the network element, or an absolute quantity of resources that are available. Other technical features may be readily apparent to one skilled in the art from the following figures, descriptions, and claims.

Another method for performing the techniques described herein is provided. The method may include causing transmission, towards a network element of a wireless communications system, information indicative of an association between (i) a plurality of implementations for the network element of the wireless communications system to perform a respective task and (ii) required allocations of resources for the network element to perform the respective task in accordance with one or more respective implementations of the plurality of implementations, and receiving, from the network element, information indicative of a first implementation to perform the respective task.

In some cases, the plurality of implementations correspond to one or more of: one or more implementations for the network element associated with respective artificial intelligence or machine learning enabled features or feature groups, one or more implementations for the network element associated with respective artificial intelligence or machine learning enabled functionalities, or one or more implementation variants for the network element associated with a given artificial intelligence or machine learning enabled functionality.

In some cases, the plurality of implementations comprise one or more implementations for the network element to perform the respective task relying on artificial intelligence or machine learning. In some cases, the plurality of implementations comprise one or more implementations for the network element to perform the respective task that do not rely on artificial intelligence or machine learning. In some cases, respective implementations out of the plurality of implementations are assigned respective priorities.

The method of an example embodiment may also include receiving, from the network element, resource availability information for the network element, where the plurality of implementations are based at least in part on the resource availability information. In some cases, two or more implementations of the plurality of implementations are associated with different types of artificial intelligence or machine learning models. In some cases, the resource availability information includes one or more of: availability information of processing resources for the network element, availability information of memory resources for the network element, battery life information of the network element, availability information of one or more inputs of the network element, availability information of one or more outputs of the network element, a connection status of the network element with the wireless communications system, or a connection quality of the network element with the wireless communications system. In some cases, the resource availability information may include, in addition to other examples of resource availability information described herein (e.g., physical resources at the network clement for performing the task), availability information for resources that are allocated by another network entity to the network entity performing the respective task. As an example, if the network entity is a device performing a positioning task, the resource availability information may include a quantity of positioning reference signals and/or a quantity of transmission/reception points that are detected at the network entity. In such cases, “detection” may occur if received power for positioning reference signals from transmission/reception points satisfies (e.g., is above) a specified threshold. The threshold may be specified for time and frequency resources allocated to the detected positioning reference signals. In some cases, the resource availability information indicates whether the resource availability information is dynamic or static, where dynamic resource availability information is valid for a limited time duration. In some cases, the level of dynamic resource availability can involve multiple levels of dynamicity, such that the availability of resources can range from being fully static (i.e., no dynamicity) to being fully dynamic (i.e., to vary in the lowest level of time unit), or any dynamicity level in between. In some cases, the resource availability information is indicative of one or more of: a geographic area in which one or more resources for the network element are available, and outside of which the one or more resources for the network element are unavailable, or a period of time during which the one or more resources for the network element are available, and outside of which the one or more resources for the network element are unavailable.

In some cases, the resource availability information is indicative of one of: a percentage of resources that are available with respect to a total quantity of respective resources for the network element, a percentage of resources that are available with respect to a threshold quantity of the respective resources for the network element, or an absolute quantity of resources that are available. Other technical features may be readily apparent to one skilled in the art from the following figures, descriptions, and claims.

An apparatus for performing the techniques described herein is provided. The apparatus may include at least one processor. The apparatus also includes at least one memory storing instructions that, when executed by the at least one processor, cause the apparatus at least to receive, from a network node of a wireless communications system, information indicative of an association between (i) a plurality of implementations for a network element of the wireless communications system to perform a respective task and (ii) required allocations of resources for the network element to perform the respective task in accordance with one or more respective implementations of the plurality of implementations, select a first implementation of the plurality of implementations to perform the respective task based at least in part on available resources for the network clement to perform the respective task relative to the required allocation of resources to perform the respective task in accordance with the first implementation, and perform the respective task in accordance with the first implementation.

The instructions may also cause the apparatus to at least cause transmission, to the network node, of information indicative of the first implementation selected to perform the respective task. In some cases, the plurality of implementations correspond to one or more of: one or more implementations for the network element associated with respective artificial intelligence or machine learning enabled features or feature groups, one or more implementations for the network element associated with respective artificial intelligence or machine learning enabled functionalities, or one or more implementation variants for the network element associated with a given artificial intelligence or machine learning enabled functionality.

In some cases, the plurality of implementations comprise one or more implementations for performing the respective task relying on artificial intelligence or machine learning. In some cases, the plurality of implementations comprise one or more implementations for performing the respective task that do not rely on artificial intelligence or machine learning. In some cases, selecting the first implementation out of the plurality of implementations is based at least in part on priorities associated with respective implementations of the plurality of implementations.

In some cases, the instructions, when executed by the at least one processor, further cause the apparatus to at least cause transmission, to the network node, of resource availability information, where the plurality of implementations are based at least in part on the resource availability information. In some cases, two or more implementations of the plurality of implementations are associated with different types of artificial intelligence or machine learning models. In some cases, the resource availability information includes one or more of: availability information of processing resources for the network element, availability information of memory resources for the network element, battery life information of the network element, availability information of one or more inputs to use for performing the respective task, availability information of one or more outputs to use for the respective task, a connection status of the network element with the wireless communications system, or a connection quality of the network element with the wireless communications system. In some cases, the resource availability information may include, in addition to other examples of resource availability information described herein (e.g., physical resources at the network element for performing the task), availability information for resources that are allocated by another network entity to the network entity performing the respective task. As an example, if the network entity is a device performing a positioning task, the resource availability information may include a quantity of positioning reference signals and/or a quantity of transmission/reception points that are detected at the network entity. In such cases, “detection” may occur if received power for positioning reference signals from transmission/reception points satisfies (e.g., is above) a specified threshold. The threshold may be specified for time and frequency resources allocated to the detected positioning reference signals.

In some cases, the resource availability information indicates whether the resource availability information is dynamic or static, where dynamic resource availability information is valid for a limited time duration. In some cases, the level of dynamic resource availability can involve multiple levels of dynamicity, such that the availability of resources can range from being fully static (i.e., no dynamicity) to being fully dynamic (i.e., to vary in the lowest level of time unit), or any dynamicity level in between. In some cases, the resource availability information is indicative of one or more of: a geographic area in which one or more resources for the network element are available, and outside of which the one or more resources for the network element are unavailable, or a period of time during which the one or more resources for the network element are available, and outside of which the one or more resources for the network element are unavailable.

In some cases, the resource availability information is indicative of one of: a percentage of resources that are available with respect to a total quantity of respective resources for the network element, a percentage of resources that are available with respect to a threshold quantity of the respective resources for the network element, or an absolute quantity of resources that are available. Other technical features may be readily apparent to one skilled in the art from the following figures, descriptions, and claims.

Another apparatus for performing the techniques described herein is provided. The apparatus may include at least one processor. The apparatus also includes at least one memory storing instructions that, when executed by the at least one processor, cause the apparatus at least to perform cause transmission, towards a network element of a wireless communications system, information indicative of an association between (i) a plurality of implementations for the network element of the wireless communications system to perform a respective task and (ii) required allocations of resources for the network element to perform the respective task in accordance with one or more respective implementations of the plurality of implementations, and receive, from the network element, information indicative of a first implementation to perform the respective task.

In some cases, the plurality of implementations correspond to one or more of: one or more implementations for the network element associated with respective artificial intelligence or machine learning enabled features or feature groups, one or more implementations for the network element associated with respective artificial intelligence or machine learning enabled functionalities, or one or more implementation variants for the network element associated with a given artificial intelligence or machine learning enabled functionality.

In some cases, the plurality of implementations comprise one or more implementations for the network element to perform the respective task relying on artificial intelligence or machine learning. In some cases, the plurality of implementations comprise one or more implementations for the network element to perform the respective task that do not rely on artificial intelligence or machine learning. In some cases, respective implementations out of the plurality of implementations are assigned respective priorities.

In some cases, the instructions, when executed by the at least one processor, further cause the apparatus to at least receive, from the network element, resource availability information for the network element, where the plurality of implementations are based at least in part on the resource availability information. In some cases, two or more implementations of the plurality of implementations are associated with different types of artificial intelligence or machine learning models.

In some cases, the resource availability information includes one or more of: availability information of processing resources for the network element, availability information of memory resources for the network element, battery life information of the network element, availability information of one or more inputs of the network element, availability information of one or more outputs of the network element, a connection status of the network element with the wireless communications system, or a connection quality of the network element with the wireless communications system. In some cases, the resource availability information may include, in addition to other examples of resource availability information described herein (e.g., physical resources at the network element for performing the task), availability information for resources that are allocated by another network entity to the network entity performing the respective task. As an example, if the network entity is a device performing a positioning task, the resource availability information may include a quantity of positioning reference signals and/or a quantity of transmission/reception points that are detected at the network entity. In such cases, “detection” may occur if received power for positioning reference signals from transmission/reception points satisfies (e.g., is above) a specified threshold. The threshold may be specified for time and frequency resources allocated to the detected positioning reference signals.

In some cases, the resource availability information indicates whether the resource availability information is dynamic or static, where dynamic resource availability information is valid for a limited time duration. In some cases, the level of dynamic resource availability can involve multiple levels of dynamicity, such that the availability of resources can range from being fully static (i.e., no dynamicity) to being fully dynamic (i.e., to vary in the lowest level of time unit), or any dynamicity level in between. In some cases, the resource availability information is indicative of one or more of: a geographic area in which one or more resources for the network element are available, and outside of which the one or more resources for the network element are unavailable, or a period of time during which the one or more resources for the network element are available, and outside of which the one or more resources for the network element are unavailable.

In some cases, the resource availability information is indicative of one of: a percentage of resources that are available with respect to a total quantity of respective resources for the network element, a percentage of resources that are available with respect to a threshold quantity of the respective resources for the network element, or an absolute quantity of resources that are available. Other technical features may be readily apparent to one skilled in the art from the following figures, descriptions, and claims.

A non-transitory computer-readable medium is provided in accordance with another example embodiment. The non-transitory computer-readable medium may include program instructions stored thereon that are configured for receiving, from a network node of a wireless communications system, information indicative of an association between (i) a plurality of implementations for a network element of the wireless communications system to perform a respective task and (ii) required allocations of resources for the network element to perform the respective task in accordance with one or more respective implementations of the plurality of implementations, selecting a first implementation of the plurality of implementations to perform the respective task based at least in part on available resources for the network element to perform the respective task relative to the required allocation of resources to perform the respective task in accordance with the first implementation, and performing the respective task in accordance with the first implementation.

The instructions may be further configured to at least cause transmission, to the network node, of information indicative of the first implementation selected to perform the respective task. In some cases, the plurality of implementations correspond to one or more of: one or more implementations for the network element associated with respective artificial intelligence or machine learning enabled features or feature groups, one or more implementations for the network element associated with respective artificial intelligence or machine learning enabled functionalities, or one or more implementation variants for the network element associated with a given artificial intelligence or machine learning enabled functionality.

In some cases, the plurality of implementations comprise one or more implementations for performing the respective task relying on artificial intelligence or machine learning. In some cases, the plurality of implementations comprise one or more implementations for performing the respective task that do not rely on artificial intelligence or machine learning. In some cases, selecting the first implementation out of the plurality of implementations is based at least in part on priorities associated with respective implementations of the plurality of implementations.

In some cases, the instructions are further configured to perform at least causing transmission, to the network node, of resource availability information, where the plurality of implementations are based at least in part on the resource availability information. In some cases, two or more implementations of the plurality of implementations are associated with different types of artificial intelligence or machine learning models. In some cases, the resource availability information includes one or more of: availability information of processing resources for the network element, availability information of memory resources for the network element, battery life information of the network element, availability information of one or more inputs to use for performing the respective task, availability information of one or more outputs to use for the respective task, a connection status of the network element with the wireless communications system, or a connection quality of the network element with the wireless communications system. In some cases, the resource availability information may include, in addition to other examples of resource availability information described herein (e.g., physical resources at the network clement for performing the task), availability information for resources that are allocated by another network entity to the network entity performing the respective task. As an example, if the network entity is a device performing a positioning task, the resource availability information may include a quantity of positioning reference signals and/or a quantity of transmission/reception points that are detected at the network entity. In such cases, “detection” may occur if received power for positioning reference signals from transmission/reception points satisfies (e.g., is above) a specified threshold. The threshold may be specified for time and frequency resources allocated to the detected positioning reference signals.

In some cases, the resource availability information indicates whether the resource availability information is dynamic or static, where dynamic resource availability information is valid for a limited time duration. In some cases, the level of dynamic resource availability can involve multiple levels of dynamicity, such that the availability of resources can range from being fully static (i.e., no dynamicity) to being fully dynamic (i.e., to vary in the lowest level of time unit), or any dynamicity level in between. In some cases, the resource availability information is indicative of one or more of: a geographic area in which one or more resources for the network element are available, and outside of which the one or more resources for the network element are unavailable, or a period of time during which the one or more resources for the network element are available, and outside of which the one or more resources for the network element are unavailable.

In some cases, the resource availability information is indicative of one of: a percentage of resources that are available with respect to a total quantity of respective resources for the network element, a percentage of resources that are available with respect to a threshold quantity of the respective resources for the network element, or an absolute quantity of resources that are available. Other technical features may be readily apparent to one skilled in the art from the following figures, descriptions, and claims.

Another non-transitory computer-readable medium is provided in accordance with another example embodiment. The non-transitory computer-readable medium may include program instructions stored thereon that are configured for causing transmission, towards a network element of a wireless communications system, information indicative of an association between (i) a plurality of implementations for the network element of the wireless communications system to perform a respective task and (ii) required allocations of resources for the network element to perform the respective task in accordance with one or more respective implementations of the plurality of implementations, and receiving, from the network element, information indicative of a first implementation to perform the respective task.

In some cases, the plurality of implementations correspond to one or more of: one or more implementations for the network element associated with respective artificial intelligence or machine learning enabled features or feature groups, one or more implementations for the network element associated with respective artificial intelligence or machine learning enabled functionalities, or one or more implementation variants for the network element associated with a given artificial intelligence or machine learning enabled functionality.

In some cases, the plurality of implementations comprise one or more implementations for the network element to perform the respective task relying on artificial intelligence or machine learning. In some cases, the plurality of implementations comprise one or more implementations for the network element to perform the respective task that do not rely on artificial intelligence or machine learning.

In some cases, respective implementations out of the plurality of implementations are assigned respective priorities. In some cases, the instructions are further configured to perform at least receiving, from the network element, resource availability information for the network element, where the plurality of implementations are based at least in part on the resource availability information. In some cases, two or more implementations of the plurality of implementations are associated with different types of artificial intelligence or machine learning models.

In some cases, the resource availability information includes one or more of: availability information of processing resources for the network element, availability information of memory resources for the network element, battery life information of the network element, availability information of one or more inputs of the network element, availability information of one or more outputs of the network element, a connection status of the network element with the wireless communications system, or a connection quality of the network element with the wireless communications system. In some cases, the resource availability information may include, in addition to other examples of resource availability information described herein (e.g., physical resources at the network element for performing the task), availability information for resources that are allocated by another network entity to the network entity performing the respective task. As an example, if the network entity is a device performing a positioning task, the resource availability information may include a quantity of positioning reference signals and/or a quantity of transmission/reception points that are detected at the network entity. In such cases, “detection” may occur if received power for positioning reference signals from transmission/reception points satisfies (e.g., is above) a specified threshold. The threshold may be specified for time and frequency resources allocated to the detected positioning reference signals.

In some cases, the resource availability information indicates whether the resource availability information is dynamic or static, where dynamic resource availability information is valid for a limited time duration. In some cases, the level of dynamic resource availability can involve multiple levels of dynamicity, such that the availability of resources can range from being fully static (i.e., no dynamicity) to being fully dynamic (i.e., to vary in the lowest level of time unit), or any dynamicity level in between. In some cases, the resource availability information is indicative of one or more of: a geographic area in which one or more resources for the network element are available, and outside of which the one or more resources for the network element are unavailable, or a period of time during which the one or more resources for the network element are available, and outside of which the one or more resources for the network element are unavailable.

In some cases, the resource availability information is indicative of one of: a percentage of resources that are available with respect to a total quantity of respective resources for the network element, a percentage of resources that are available with respect to a threshold quantity of the respective resources for the network element, or an absolute quantity of resources that are available. Other technical features may be readily apparent to one skilled in the art from the following figures, descriptions, and claims.

Another apparatus is provided in accordance with a further example embodiment. The apparatus may include means for receiving, from a network node of a wireless communications system, information indicative of an association between (i) a plurality of implementations for a network element of the wireless communications system to perform a respective task and (ii) required allocations of resources for the network element to perform the respective task in accordance with one or more respective implementations of the plurality of implementations, means for selecting a first implementation of the plurality of implementations to perform the respective task based at least in part on available resources for the network element to perform the respective task relative to the required allocation of resources to perform the respective task in accordance with the first implementation, and means for performing the respective task in accordance with the first implementation.

The apparatus may also include means for causing transmission, to the network node, of information indicative of the first implementation selected to perform the respective task. In some cases, the plurality of implementations correspond to one or more of: one or more implementations for the network element associated with respective artificial intelligence or machine learning enabled features or feature groups, one or more implementations for the network element associated with respective artificial intelligence or machine learning enabled functionalities, or one or more implementation variants for the network element associated with a given artificial intelligence or machine learning enabled functionality.

In some cases, the plurality of implementations comprise one or more implementations for performing the respective task relying on artificial intelligence or machine learning. In some cases, the plurality of implementations comprise one or more implementations for performing the respective task that do not rely on artificial intelligence or machine learning. In some cases, selecting the first implementation out of the plurality of implementations is based at least in part on priorities associated with respective implementations of the plurality of implementations.

The apparatus may also include means for causing transmission, to the network node, of resource availability information, where the plurality of implementations are based at least in part on the resource availability information. In some cases, two or more implementations of the plurality of implementations are associated with different types of artificial intelligence or machine learning models. In some cases, the resource availability information includes one or more of: availability information of processing resources for the network element, availability information of memory resources for the network element, battery life information of the network clement, availability information of one or more inputs to use for performing the respective task, availability information of one or more outputs to use for the respective task, a connection status of the network element with the wireless communications system, or a connection quality of the network element with the wireless communications system. In some cases, the resource availability information may include, in addition to other examples of resource availability information described herein (e.g., physical resources at the network element for performing the task), availability information for resources that are allocated by another network entity to the network entity performing the respective task. As an example, if the network entity is a device performing a positioning task, the resource availability information may include a quantity of positioning reference signals and/or a quantity of transmission/reception points that are detected at the network entity. In such cases, “detection” may occur if received power for positioning reference signals from transmission/reception points satisfies (e.g., is above) a specified threshold. The threshold may be specified for time and frequency resources allocated to the detected positioning reference signals.

In some cases, the resource availability information indicates whether the resource availability information is dynamic or static, where dynamic resource availability information is valid for a limited time duration. In some cases, the level of dynamic resource availability can involve multiple levels of dynamicity, such that the availability of resources can range from being fully static (i.e., no dynamicity) to being fully dynamic (i.e., to vary in the lowest level of time unit), or any dynamicity level in between. In some cases, the resource availability information is indicative of one or more of: a geographic area in which one or more resources for the network element are available, and outside of which the one or more resources for the network element are unavailable, or a period of time during which the one or more resources for the network element are available, and outside of which the one or more resources for the network element are unavailable.

In some cases, the resource availability information is indicative of one of: a percentage of resources that are available with respect to a total quantity of respective resources for the network element, a percentage of resources that are available with respect to a threshold quantity of the respective resources for the network element, or an absolute quantity of resources that are available. Other technical features may be readily apparent to one skilled in the art from the following figures, descriptions, and claims.

Another apparatus is provided in accordance with yet another example embodiment. The apparatus may include means for causing transmission, towards a network element of a wireless communications system, information indicative of an association between (i) a plurality of implementations for the network element of the wireless communications system to perform a respective task and (ii) required allocations of resources for the network element to perform the respective task in accordance with one or more respective implementations of the plurality of implementations, and means for receiving, from the network element, information indicative of a first implementation to perform the respective task.

In some cases, the plurality of implementations correspond to one or more of: one or more implementations for the network element associated with respective artificial intelligence or machine learning enabled features or feature groups, one or more implementations for the network element associated with respective artificial intelligence or machine learning enabled functionalities, or one or more implementation variants for the network element associated with a given artificial intelligence or machine learning enabled functionality.

In some cases, the plurality of implementations comprise one or more implementations for the network element to perform the respective task relying on artificial intelligence or machine learning. In some cases, the plurality of implementations comprise one or more implementations for the network element to perform the respective task that do not rely on artificial intelligence or machine learning. In some cases, respective implementations out of the plurality of implementations are assigned respective priorities.

The apparatus may also include means for receiving, from the network element, resource availability information for the network element, where the plurality of implementations are based at least in part on the resource availability information. In some cases, two or more implementations of the plurality of implementations are associated with different types of artificial intelligence or machine learning models. In some cases, the resource availability information includes one or more of: availability information of processing resources for the network element, availability information of memory resources for the network element, battery life information of the network element, availability information of one or more inputs of the network element, availability information of one or more outputs of the network element, a connection status of the network element with the wireless communications system, or a connection quality of the network element with the wireless communications system. In some cases, the resource availability information may include, in addition to other examples of resource availability information described herein (e.g., physical resources at the network element for performing the task), availability information for resources that are allocated by another network entity to the network entity performing the respective task. As an example, if the network entity is a device performing a positioning task, the resource availability information may include a quantity of positioning reference signals and/or a quantity of transmission/reception points that are detected at the network entity. In such cases, “detection” may occur if received power for positioning reference signals from transmission/reception points satisfies (e.g., is above) a specified threshold. The threshold may be specified for time and frequency resources allocated to the detected positioning reference signals.

In some cases, the resource availability information indicates whether the resource availability information is dynamic or static, where dynamic resource availability information is valid for a limited time duration. In some cases, the level of dynamic resource availability can involve multiple levels of dynamicity, such that the availability of resources can range from being fully static (i.e., no dynamicity) to being fully dynamic (i.e., to vary in the lowest level of time unit), or any dynamicity level in between. In some cases, the resource availability information is indicative of one or more of: a geographic area in which one or more resources for the network element are available, and outside of which the one or more resources for the network element are unavailable, or a period of time during which the one or more resources for the network element are available, and outside of which the one or more resources for the network element are unavailable.

In some cases, the resource availability information is indicative of one of: a percentage of resources that are available with respect to a total quantity of respective resources for the network element, a percentage of resources that are available with respect to a threshold quantity of the respective resources for the network element, or an absolute quantity of resources that are available. Other technical features may be readily apparent to one skilled in the art from the following figures, descriptions, and claims.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 illustrates a wireless communications system via which a user equipment (UE) and one or more base stations may be configured to proactively communicate resource mappings;

FIG. 2 is a block diagram of an apparatus that may be specifically configured in accordance with an example embodiment of the present disclosure;

FIG. 3 illustrates a signal flow diagram that supports techniques for communicating resource mappings between a network element, a network node, and a lifecycle management (LCM) entity;

FIG. 4 illustrates tables for communicating or otherwise storing information associated with resources for performing various tasks; and

FIGS. 5 and 6 are flowcharts of operations according to certain example embodiments implemented, for example, by an apparatus as described herein.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device (such as a core network apparatus), field programmable gate array, and/or other computing device.

As used herein, the term “computer-readable medium” refers to non-transitory storage hardware, non-transitory storage device or non-transitory computer system memory that may be accessed by a controller, a microcontroller, a computational system or a module of a computational system to encode thereon computer-executable instructions or software programs. A non-transitory “computer-readable medium” may be accessed by a computational system or a module of a computational system to retrieve and/or execute the computer-executable instructions or software programs encoded on the medium. Examples of non-transitory computer-readable media may include, but are not limited to, one or more types of hardware memory, non-transitory tangible media (for example, one or more magnetic storage disks, one or more optical disks, one or more USB flash drives), computer system memory or random-access memory (such as, DRAM, SRAM, EDO RAM), and the like.

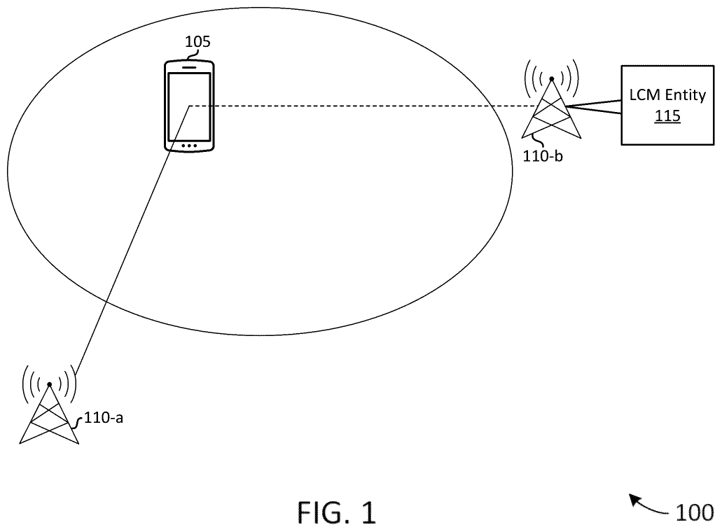

FIG. 1 illustrates an example of a wireless communications system 100 that supports methods and apparatuses for proactive communication of resource mappings to network element implementations for performing a task. In some embodiments, the wireless communications system 100 may include one or more UEs 105 and one or more base stations 110 of a radio access network (RAN), which may be in communication with each other. The one or more base stations 110 may be examples of network entities and may be embodied by any of a variety of access points or nodes including, for example, a Node B (e.g., a gNB), or the like of a RAN. In some cases, the UEs 105 and/or the RAN, such as the base stations 110 of the RAN, may be in communication with a core network including one or more network nodes of the core network. As shown in FIG. 1, the network nodes of an example embodiment may include one or more lifecycle management (LCM) entities 115, e.g., hosted by a location management function (LMF). An LCM entity 115 may be an example of a virtualized entity implemented, for example, by software, and responsible for performing one or more operations related to lifecycle management.

By way of example, the wireless communications system 100 may be deployed within a radio access architecture based on long term evolution advanced (LTE Advanced, LTE-A) and/or new radio (NR, 5G). However, the system may be deployed in other network architectures including within other communication networks including, for example, other communication networks developed in the future, e.g., sixth generation (6G) networks, as well as any of a number of existing networks including a universal mobile telecommunication system (UMTS), radio access network (UTRAN or E-UTRAN), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

The UE 105 may be any type of user terminal, terminal device, node (e.g., network node), clement (e.g., network element), etc. to which resources on the air interface are allocated and assigned. For example, the UE 105 may be a portable computing device such as a wireless mobile communication device including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, multimedia device, car, truck, drone, airplane and other types of vehicles. As a non-exhaustive list of some examples, the UE 105 may also be called a subscriber unit, mobile station, network element, remote terminal, access terminal, or user terminal.

The techniques and apparatuses described herein may relate to implementations embodied by a network element, such as a UE 105, for performing a task utilizing artificial intelligence. While some examples described herein refer broadly to artificial intelligence, it should be understood that the term “artificial intelligence” encompasses any type of artificial intelligence, such as machine learning, deep learning, narrow artificial intelligence (e.g., weak artificial intelligence), general artificial intelligence (e.g., strong artificial intelligence), natural language processing (NLP), computer vision, and the like.

Some communication devices (e.g., a UE 105, a base station 110) may employ artificial intelligence (e.g., artificial intelligence/machine learning) to perform one or more tasks relevant to a use case application of artificial intelligence (e.g., using artificial intelligence for UE positioning). For example, a communication device may utilize artificial intelligence for channel state information (CSI) feedback (e.g., for CSI feedback enhancement). In such cases, a communication device may perform spatial and/or frequency domain CSI compression using artificial intelligence (e.g., using a two-sided artificial intelligence model). Additionally, or alternatively, a communication device may perform time domain CSI prediction using artificial intelligence (e.g., using a UE-sided model).

In some cases, a communication device may utilize artificial intelligence for beam management. For example, a communication device may perform spatial domain downlink beam prediction for a first set of beams based on measurement results for a second set of beams (e.g., historic measurement results for the second set of beams). Additionally, or alternatively, a communication device may perform temporal downlink beam prediction for a first set of beams based on measurement results for a second set of beams (e.g., historic measurement results for the second set of beams).

In some cases, a communication device may utilize artificial intelligence for positioning (e.g., for positioning accuracy enhancements). For example, a communication device may perform direct artificial intelligence positioning. In such cases, the communication device may utilize an artificial intelligence model to output a location of the communication device (e.g., a location for the UE 105). Additionally, or alternatively, the communication device may perform one or more fingerprinting operations based on channel observations used as input for the artificial intelligence model. In some cases, a communication device may perform one or more artificial intelligence-assisted positioning operations. For example, a communication device may utilize an artificial intelligence model to output a new measurement or enhancement of an existing measurement (e.g., a measurement of the position of the communication device). Additionally, or alternatively, the communication device may perform (e.g., using the artificial intelligence model) line-of-sight (LOS) or non-line-of-sight (NLOS) identification, timing and/or angle measurement, and/or one or more operations to determine a likelihood of a measurement (e.g., a likelihood that a communication device is located at a given position).

Artificial intelligence may be utilized by a variety of communication devices within a wireless communications system 100. Several scenarios or use cases may utilize artificial intelligence in conjunction with positioning tasks. For example, a first use case (e.g., case 1) may include UE-based positioning (e.g., for determining one or more positions of the UE 105) using a UE-side model (e.g., a model executed by the UE 105). The first use case may also include direct artificial intelligence or artificial intelligence-assisted positioning, which is also referred to as one-step positioning. A second use case (e.g., case 2) may include UE-assisted and location management function (LMF)-based positioning using a UE-side model. For example, the artificial intelligence operations (e.g., the artificial intelligence model) may be executed or performed by the UE 105. The second use case may also include artificial intelligence-assisted positioning, which is also referred to as two-step positioning. A third use case (e.g., case 3) may include next generation (NG) radio access network (RAN) assisted positioning using a base station-side model. For example, the artificial intelligence operations (e.g., the artificial intelligence model) may be executed or performed by a base station 110. The third use case may also include artificial intelligence-assisted (e.g., two-step) positioning.

Although the use cases described herein may refer to positioning operations as one illustrative example, any type of artificial intelligence operation may be implemented for a given use case. For example, any of the use cases described above may be applied to CSI feedback operations, beam management operations, or any other operations performed by a communication device. Additionally, any type of communication device, also referenced as a network element, may perform or execute artificial intelligence operations. In some cases, multiple types of communication devices may perform artificial intelligence operations (e.g., concurrently, for a same process). For example, a UE 105 and a base station 110 may both perform beam management operations using artificial intelligence.

Some examples described herein may refer to the network node as an LMF, which may be an example of an LCM entity 115 or an LCM function. In some cases, an LMF may perform one or more operations to manage the locations of communication devices (e.g., UEs 105) within a wireless communications system 100. For example, when a UE 105 registers with a network or moves into a coverage area of a base station 110, an LMF may process location updates and ensure that the network (e.g., the base station 110) has the current location of the UE 105. In some cases, an LMF may be a virtualized entity and may run on specific network servers or network nodes (e.g., base stations 110). An LMF may be implemented by any of a variety of network nodes in the core radio network.

Some techniques and devices described herein may relate to or be implemented as protocols or standardized procedures for communication devices. Such techniques may include communicating capability indications, configuration and control procedures (e.g., training procedures, inference procedures), management of data, and management of artificial intelligence models (e.g., LCM for artificial intelligence models). In some cases, LCM may relate to or may include performing operations for data collection (e.g., including associated assistance information, if applicable), model training, functionality/model identification, model inference operation, functionality/model selection, functionality/model activation, functionality/model deactivation, functionality/model switching, functionality/model monitoring, model updating, model tuning (e.g., model finetuning), model retraining, model re-development via online/offline training, UE capability, determinations made by a UE 105 (e.g., event-triggered as configured by the network, UE determinations reported to the network, UE autonomous decisions with or without UE determinations reported to the network), and determinations made by a base station 110 (e.g., either network initiated or UE-initiated and requested to the network).

An artificial intelligence model may have a model identifier (ID), which may indicate the model (e.g., by type, by parameters associated with the model). In some cases, the model ID may indicate a model functionality for one or more artificial intelligence operations. The model ID may include one or more bits or other parameters, which may correspond to the model (e.g., the model type, one or more parameters of the model, the model functionality). One or more functionalities of an artificial intelligence model may be identified using various techniques. For example, some 3GPP frameworks (e.g., utilized for other identifications) may be utilized for functionality identification. In some cases, a UE 105 may indicate one or more supported functionalities (e.g., artificial intelligence model functionalities) for a specific use case (e.g., for a sub-use case). In some cases, techniques for indicating UE capabilities may be adapted to also include one or more indications of artificial intelligence model functionalities. In some cases, a model ID may be identified by a model ID at the network. Additionally, or alternatively, a UE 105 may indicate one or more supported artificial intelligence models. The techniques for indicating model IDs and functionalities described herein may be utilized for UE-side models and a UE-portion of two-sided models.

For functionality-based LCM, the network (e.g., the core network) may indicate activation/deactivation/fallback/switching of artificial intelligence functionalities via 3GPP signaling (e.g., radio resource control (RRC) signaling, medium access control element (MAC-CE) signaling, downlink control information (DCI) signaling). In some cases, one or more artificial intelligence models may not be identified at the network, and a UE 105 may perform model-level LCM operations. In some other cases, one or more artificial intelligence models may be identified at the network. In some cases, one or more functionalities may be defined within an artificial-intelligence-enabled feature (e.g., a feature where artificial intelligence may be used).

Some examples described herein may refer to features, functionalities, and models that may be performed utilizing artificial intelligence. A feature may be a capability (e.g., an ability) of a communication device to perform a task or operation. For example, a UE 105 may have a positioning feature (e.g., a location tracking feature), which may enable a location of the UE 105 to be determined (e.g., by the UE 105, by a base station 110). A functionality may describe how a communication device performs a feature or one or more conditions associated with the feature. For example, a functionality may specify a quantity of antenna ports that a UE 105 uses to perform a positioning feature. In some cases, each feature may be associated with one or more functionalities. A model may be a program or algorithm that is executed by a communication device to perform one or more features or tasks. For example, a UE 105 with an artificial-intelligence-enabled positioning feature may execute an artificial intelligence model to perform the feature. Some examples described herein may also refer to feature groups. A feature group may include a set of features. In some cases, the features included in a feature group may relate to a common theme or function of a communication device. As described herein, the term “implementation” may be used to collectively and generically refer to features, functionalities, and models. For example, the term “implementation” may describe various options for utilizing features, functionalities, models, or any combination thereof.

For artificial intelligence functionality identification and functionality-based LCM of UE-side models and/or a UE-part of two-sided models, the term “functionality” may refer to an artificial-intelligence-enabled feature or feature group (FG) enabled by one or more configurations, where the one or more configurations are supported based on conditions indicated by UE capability. Additionally, or alternatively, functionality-based LCM operates based on one or more configurations of artificial-intelligence-enabled features, feature groups (FGs), or specific configurations of an artificial-intelligence-enabled feature or FG.

In addition to functionality identification, mechanisms for a UE 105 to report updates on applicable functionalities among configured/identified functionalities are described. In some cases, a UE 105 may or may not report updates on applicable functionalities. In some cases, applicable functionalities may be a subset of all configured/identified functionalities. In model-ID-based LCM, models are identified at the network. In such cases, the network, a UE 105, or both, may activate/deactivate/select/switch individual artificial intelligence models via model ID.

For artificial intelligence model identification and model-ID-based LCM of UE-side models and the UE-part of two-sided models, model-ID-based LCM may operate based on identified models, where a model may be associated with one or more specific configurations or conditions associated with UE capability for an artificial-intelligence-enabled feature or feature group. Additionally, or alternatively, a model may be associated with one or more specification configurations or conditions associated with additional conditions (e.g., scenarios, sites, datasets) as determined or otherwise identified by a UE 105 or a base station 110.

In some cases, an artificial intelligence model identified by a model ID may be logical, and how it maps to physical artificial intelligence models may be up to implementation (e.g., implementation by a UE 105). In some cases, the phrase “logical artificial intelligence model” may refer to a model that is identified and assigned a model ID, and the phrase “physical artificial intelligence model” may refer to an actual implementation of such a model.

Efficiency of selection, activation, deactivation, switching, and fallback for artificial intelligence operations (e.g., tasks, functionalities, models) may play a key role in effective utilization of artificial intelligence at a communication device. As described herein, the term “switching” may refer to deactivation of a first model (e.g., a current model) and activation of a second model (e.g., a new model) to perform the same task. Additionally, the term “fallback” may refer to deactivating an artificial intelligence model and performing a task without using the artificial intelligence model, for instance using a legacy implementation.

In some cases, one or more capabilities (e.g., resource availability conditions) of a UE 105 may be relatively static (e.g., not expected to change within a relatively short time frame). In some other cases, one or more capabilities of a UE 105 may be relatively dynamic. For example, one or more conditions (e.g., dynamic conditions) may impact whether a UE 105 utilizes or switches to an artificial intelligence functionality/model at a certain time. Examples of such conditions include the availability of resources, such as processing power of a UE 105 to perform one or more artificial intelligence functions. While an artificial intelligence model is utilized by a UE 105 to perform one or more tasks (e.g., position estimation), the UE 105 may perform as expected in a certain environment and situation, but the UE 105 may not be able to run the artificial intelligence model due to a central processing unit (CPU) of the UE 105 being overloaded. For example, resources of the CPU may be prioritized or allocated for other tasks, which may yield an unexpected but temporary drop in the performance of the artificial intelligence model. In such cases, switching to another model with similar resource availability requirements may not improve the ability of the UE 105 to run the artificial intelligence model. However, the UE 105 of an example embodiment may be configured to address model selection, activation, deactivation, switching, and fallback under such resource-constrained situations for the UE 105.

In accordance with one or more aspects of the present disclosure, a communication device (e.g., a UE 105, a base station 110) may be configured with a plurality of implementations (e.g., options, configurations, mappings) for performing operations (e.g., tasks) using artificial intelligence and, in some instances, without the use of artificial intelligence. A communication device may be proactively configured with such implementations so that operations of the communication device may be tailored to specific resource scenarios when they occur (e.g., in a case where a UE 105 experiences a reduction in the available resources for performing artificial intelligence tasks). In accordance with the techniques described herein, a location server (e.g., an LMF) or other network node may configure a UE 105 capable of performing a task utilizing artificial intelligence (e.g., a positioning functionality) in advance of the UE 105 performing the task. Accordingly, the UE 105 may be capable of determining the implementation to utilize when processing resources are insufficient. As an example, a UE 105 may switch to a model or fallback to a non-artificial-intelligence task that has less computational complexity if there are insufficient processing resources for a more computationally intensive implementation that utilizes artificial intelligence.

In some cases, such implementations (e.g., configurations) may be associated with required resource allocations by mapping tables provided by a network node (e.g., an LCM 115, an LMF) to a UE 105, which may map requested UE-side artificial intelligence features, functionalities, or models to respective resource conditions (e.g., ranges of resources, resource boundaries) of the UE 105. According to the techniques described herein, if the current UE-side artificial intelligence feature, functionality, or model cannot be performed as desired at a UE 105, then the UE 105 may switch to a different artificial intelligence feature, functionality, or model as per implementations and associated required resource allocations provided by the network node. In some cases, the UE may switch to perform a different positioning functionality that does not involve artificial intelligence or machine learning processing, if the resource availability does not permit performing artificial intelligence-assisted positioning, as an example.

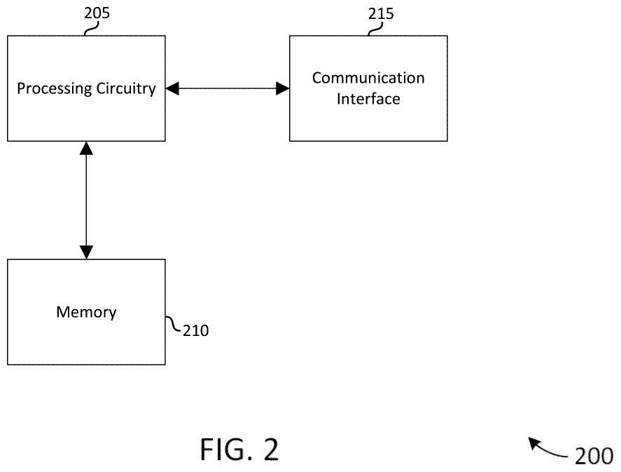

FIG. 2 illustrates an example of an apparatus 200 that supports methods for proactive communication of resource mappings to network element implementations for performing a task. The apparatus 200 may be embodied by or may comprise a network element, such as a UE 105 or a base station 110, configured to perform one or more tasks with a plurality of different implementations, at least one of which relies upon artificial intelligence. As shown in FIG. 2, the apparatus 200 may include, be associated with, or be in communication with processing circuitry 205 (e.g., one or more processors), a memory 210 and a communication interface 215. The processing circuitry may be in communication with the memory 210 via a bus for passing information among components of the apparatus. The memory 210 may be non-transitory and may include, for example, one or more volatile and/or non-volatile memories. In other words, for example, the memory 210 may be an electronic storage device (e.g., a computer readable storage medium) comprising storage components configured to store data (e.g., bits) that may be retrievable by a machine (e.g., a computing device like the processing circuitry 205). The memory 210 may be configured to store information, data, content, applications, instructions, or the like for enabling the apparatus 200 to carry out various functions in accordance with an example embodiment of the present disclosure. For example, the memory 210 may be configured to buffer input data for processing by the processing circuitry 205. Additionally, or alternatively the memory 210 may be configured to store instructions for execution by the processing circuitry 205.

The apparatus 200 may, in some embodiments, be embodied in various computing devices as described above. However, in some embodiments, the apparatus 200 may be embodied as a chip or chip set. In other words, the apparatus 200 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 200 may therefore, in some cases, be configured to implement an embodiment of the present invention on a single chip or as a single “system on a chip.” As such, in some cases, a chip or chipset may constitute means for performing one or more operations for providing the functionalities described herein.

The processing circuitry 205 may be embodied in a number of different ways. For example, the processing circuitry 205 may be embodied as one or more of various hardware processing means such as a coprocessor, a microprocessor, a controller, a digital signal processor (DSP), a processing clement with or without an accompanying DSP, or various other circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry 205 may include one or more processing cores configured to perform independently. A multi-core processing circuitry may enable multiprocessing within a single physical package. Additionally, or alternatively the processing circuitry 205 may include one or more processors configured in tandem via the bus to enable independent execution of instructions, pipelining and/or multithreading.

In an example embodiment, the processing circuitry 205 may be configured to execute instructions stored in the memory 210 or otherwise accessible to the processing circuitry 205. Additionally, or alternatively, the processing circuitry 205 may be configured to execute hard coded instructions. As such, whether configured by hardware or software methods, or by a combination thereof, the processing circuitry 205 may represent an entity (e.g., physically embodied in circuitry) capable of performing operations according to an embodiment of the present disclosure while configured accordingly. Thus, for example, when the processing circuitry 205 is embodied as an ASIC, FPGA or the like, the processing circuitry 205 may be specifically configured hardware for conducting the operations described herein. Alternatively, as another example, when the processing circuitry 205 is embodied as an executor of instructions, the instructions may specifically configure the processing circuitry 205 to perform the algorithms and/or operations described herein when the instructions are executed. However, in some cases, the processing circuitry 205 may be a processor of a specific device (e.g., an image or video processing system) configured to employ an embodiment of the present invention by further configuration of the processing circuitry 205 by instructions for performing the algorithms and/or operations described herein. The processing circuitry 205 may include, among other things, a clock, an arithmetic logic unit (ALU) and logic gates configured to support operation of the processing circuitry 205.

The communication interface 215 may be any means such as a device or circuitry embodied in either hardware or a combination of hardware and software that is configured to receive and/or transmit data, including media content in the form of video or image files, one or more audio tracks or the like. In this regard, the communication interface 215 may include, for example, an antenna (or multiple antennas) and supporting hardware and/or software for enabling communications with a wireless communication network (e.g., with one or more communication devices of the wireless communications system 100). Additionally, or alternatively the communication interface 215 may include one or more antennas to cause transmission of signals via the one or more antennas or to handle receipt of signals received via the one or more antennas. In some environments, the communication interface 215 may alternatively or also support wired communication. As such, for example, the communication interface 215 may include a communication modem and/or other hardware/software for supporting communication via cable, digital subscriber line (DSL), universal serial bus (USB) or other mechanisms.

In some cases, the apparatus 200 may be configured to perform one or more tasks relevant to a use case application of artificial intelligence (e.g., using artificial intelligence for UE positioning). For example, the apparatus 200 may be configured to utilize one or more machine learning models for one or more CSI processes, such as a CSI determination process. In such cases, the apparatus 200 may utilize the machine learning model to predict CSI for one or more channels, which may enhance one or more operations performed by the apparatus 200. In addition to machine-learning-assisted CSI processes, the apparatus 200 may utilize one or more artificial intelligence models for beam management, for positioning, or for any other type of operations performed by the apparatus 200. However, utilizing artificial models for various operations at the apparatus 200 may consume more resources than performing the same tasks without reliance upon artificial intelligence.

In accordance with one or more aspects of the present disclosure, the apparatus 200 may be configured (e.g., proactively), with a mapping table that links (e.g., associates, pairs) respective implementations (e.g., configurations, operations, features, functionalities, models, model parameters) for performing one or more tasks with corresponding required allocations of resources of the apparatus 200, where the resources refer either to the physical resources at the apparatus or the resources provided by another network entity for the apparatus to perform the respective task. The apparatus 200 may then select an implementation corresponding to a current condition of the apparatus 200, which may improve resource utilization and performance of the apparatus 200.

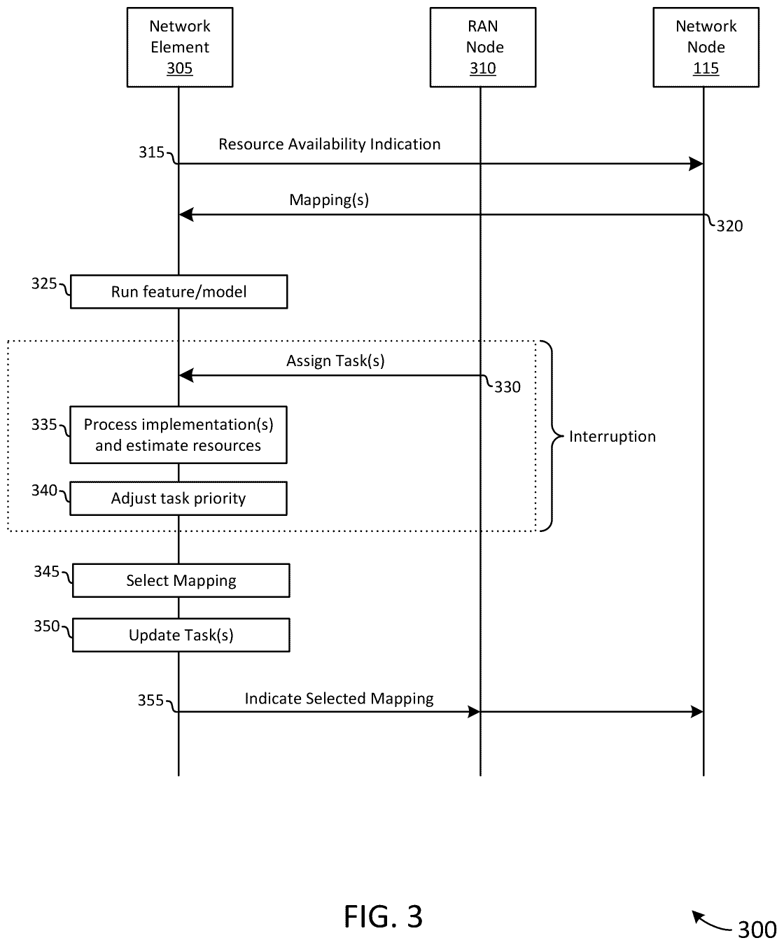

FIG. 3 illustrates an example of a signal flow diagram 300 of an example embodiment of the present disclosure. The signal flow diagram 300 may include communications between a network element 305, such as a UE, a radio access network (RAN) node 310, and a network node 115 of the core network, such as an LCM entity 115. The network clement 305, RAN node 310, and network node may be examples of communication devices or entities described with reference to FIGS. 1 and 2. For example, the network element 305 may be an example of a UE 105, the RAN node 310 may be an example of a base station 110 of the RAN, and the network node may be an LCM entity 115, such as an LMF, as described with reference to FIG. 1. The signal flow diagram 300 may depict communications between the network element 305, the RAN node 310, and the network node (e.g., an LCM 115, an LMF), in accordance with an example embodiment.

At 315, the network element 305 may cause transmission of resource availability information to the network node, e.g., the LCM entity 115. Resource availability information may be provided for a variety of types of resources. For example, the resource types may include processing power (e.g., for a graphics processing unit (GPU), for a CPU, for a tensor processing unit (TPU)), available memory (e.g., random access memory (RAM)), electrical power (e.g., battery status including relevant power level with respect to a threshold level, a CPU throttling level), input conditions for the network element 305, output conditions for the network element 305, and connection status and/or quality for the network element 305. Some example input/output conditions for the network element 305 may include one or more conditions indicating if a sensor is blocked or if sensor data is missing. In some cases, sensor-obtained data may be utilized as labels during training for radio-frequency (RF) based artificial intelligence positioning methods.

The resource availability information may include a resource availability pattern in instances in which the resource availability may vary in a predictable manner, such as based upon prior computations performed for the same task. In this regard, the resource availability pattern may be indicated by a parameter (e.g., a flag comprising one or more bits) as dynamic. The network node, e.g., the LCM entity 115, may then be aware that the resources used by the network element 305 for performing tasks, including those potentially performed using artificial intelligence (e.g., positioning tasks, beam management tasks, CSI tasks, and the like) are not constant but are allocated dynamically. Additionally, or alternatively, the network element 305 may indicate timing associated with a resource requirement (e.g., resource density). For example, an artificial intelligence model may utilize resources for a relatively short period of time per inference (that is, the resource demand of the artificial intelligence model is not constant). In some cases, the network element 305 may indicate, to the network node, e.g., the LCM entity 115, the resource availability pattern in terms of (e.g., including) an expected area (e.g., geographic area) and/or an expected period of time when artificial-intelligence-related resources for positioning, as an example, are available or at a threshold value (e.g., a minimum or maximum level or range). Such artificial-intelligence-related resources for positioning may refer to the physical resources available at network element 305 or the positioning resources provided by another network element (e.g., the LCM entity 115), for the network element 305 to perform positioning, such as a quantity of detected positioning reference signals and their respective detection or reception qualities.

In some cases, the network element 305 may indicate the geographical bounds within which it expects to deploy artificial intelligence computational resources above a given threshold (e.g., a resource threshold, a geographic threshold, a temporal threshold). In some cases, the network clement 305 may indicate, to the network node, e.g., the LCM entity 115, one or more periods of time or time windows during which computational resources are anticipated to be consumed above or below a given threshold value. By way of example, the network element 305 may be aware that during some time of the day there may be more objects in an area than during other times of the day, which may result in non-line-of-sight (NLOS) positioning being utilized, which further increases CPU demand. In such cases, the network element 305 may communicate the resource availability pattern to the network node, e.g., the LCM entity 115.

In some cases, the network element 305 may indicate to the network node, e.g., the LCM entity 115, the artificial-intelligence-related resources currently allocated for positioning as a percentage of the total available artificial-intelligence-related resources (e.g., as 20% of artificial intelligence processing power is currently dedicated for positioning-related artificial intelligence tasks). In some cases, the network element 305 indicates the percentage of the artificial-intelligence-related resources expected to be deployed for positioning as a function of a future time window. In some cases, the network element 305 indicates the percentage of the artificial-intelligence-related resources expected to be deployed for positioning as a function of a geographical area (e.g., a geofenced area). In some cases, the network element 305 indicates the positioning resources (e.g., detected positioning reference signals) provided by another network entity (e.g., the LMF or LCM entity 115) that are expected to be detectable at the network element 305 during a future time window or in a geographical area, or both.

At 320, the network node, e.g., the LCM entity 115, may cause transmission of information towards the network element 305 that is indicative of an association between (i) a plurality of implementations for a network element of the wireless communications system to perform a respective task and (ii) required allocations of resources for the network element to perform the respective task in accordance with one or more respective implementations of the plurality of implementations. In an example embodiment, this information may be in the form of one or more mappings.

In regard to a mapping table, one example of a mapping table may include one or more inputs that indicate one or more ranges (e.g., by means of minimum and/or maximum values) of the computational resources the network element 305 will need to deploy to perform the task, e.g., positioning, utilizing a particular implementation, such as an implementation that relies upon artificial intelligence or an implementation that does not rely upon artificial intelligence. The mapping table may include one or more outputs that indicate the particular implementation associated with a required resource allocation, such as one or more artificial-intelligence-related positioning functionalities as a function of the one or more required resource allocations. Examples of such positioning functionalities may include one-step positioning or direct artificial intelligence-assisted positioning (e.g., a fingerprinting positioning method) versus two-step positioning or artificial intelligence-assisted positioning (e.g., an artificial-intelligence-related method for line-of-sight (LOS) identification as well as a conventional positioning method such as downlink/uplink (DL/UL) time difference of arrival (TDoA)), iterative refinement of the location estimate by means of hybrid positioning methods (e.g., applying multiple positioning methods towards converging to a high accuracy estimate), or by means of positioning reference unit (PRU) related correction data. In some cases, the network element 305 may be configured such that if the available resources fail to satisfy a threshold (e.g., are below a threshold) associated with a particular implementation that utilizes artificial intelligence, the network element 305 may abandon the artificial-intelligence-assisted positioning implementation and revert to a non-artificial-intelligence positioning implementation (e.g., DL-TDoA, UL-TDoA, DL angle of departure (AoD), or the like). In some cases, the mapping table may include one or more inputs that indicate one or more ranges (e.g., by means of minimum and/or maximum values) of the computational resources with respect to the resources (e.g., number of detected positioning reference signals and quality of each) provided by another network node for the network element 305 to perform the respective task (e.g., artificial intelligence assisted positioning), which the network clement 305 will need to deploy to perform the task, e.g., positioning, utilizing a particular implementation, such as an implementation that relies upon artificial intelligence or an implementation that does not rely upon artificial intelligence.

In some cases, an implementation identified by the mapping table may include or be associated with a set of conditions to be fulfilled for the mapping table to apply. Such conditions may include a level of a signal-to-noise-ratio (SINR) associated with one or more positioning-related measurements, time windows during which the mapping table is valid, and/or geographical areas wherein the mapping table is valid. In some cases, the network node, such as the LCM entity 115, may assign priorities for the different implementations for performing a task that defines an order of preference. The priority order may indicate which implementation to use first for performing a task in case computational resources are limited (e.g., for the network element 305).

In some other cases, the implementation identified by the mapping table may include or be associated with one or more relaxation parameters such that a network element 305 is permitted to reduce a frequency of inference for a model (e.g., a network element 305 may be configured to be allowed to reduce the frequency of reports containing the inference output of an artificial intelligence model to temporarily make additional resources available for another model). Based on the available resources, the network element 305 may then execute the implementation, such as an artificial-intelligence-related positioning model or functionality, as configured by the network node, e.g., LCM entity 115.

In some cases, an artificial-intelligence-capable network element 305 may be capable of running parallel artificial-intelligence models simultaneously. For example, a network element 305 may simultaneously run models for positioning, CSI-feedback for massive multiple-input-multiple-output (MIMO), and beam management. In such cases, the network element 305 may, at any time, be assigned with a new task by a RAN node 310. The network element 305 may be configured to then estimate the computational resources needed for each assigned artificial-intelligence-related task. In such cases, the network element 305 may reduce the computational resources assigned for pre-existing tasks in order to have sufficient resources to perform all of the tasks in parallel, including the newly assigned task. This event may trigger operations performed at 345.

At 325, the network element 305 may execute a particular implementation of a task, such as one or more artificial intelligence models or one or more artificial intelligence features. The implementation that is utilized may be based upon the mapping table provided by the RAN node 310 and the resources available at the network element.

At 330, the RAN node 310 may optionally assign one or more additional tasks to the network element 305. The one or more tasks may be one or more tasks that may be performed utilizing an artificial intelligence implementation. For example, the RAN node 310 may assign one or more CSI feedback tasks or one or more beam management computations to the network clement 305 that is already performing an initial task utilizing an artificial intelligence implementation. By way of example but not of limitation, the initial task will be hereinafter referenced as a positioning task.

At 335, the network element 305 may process parallel artificial intelligence implementations in order to estimate the computational resources required to perform the implementations of the various tasks.

At 340, the network element 305 may adjust one or more task priorities (e.g., for the assigned one or more tasks). For example, the network element 305 may lower a priority for the positioning task as a result of the interruption from the RAN node 310 that assigned an additional task to the network element 305.

At 345, the network element 305 may select a mapping (e.g., select an implementation from the mapping table) and at 350, the network element may update the implementations performing one or more tasks that are executing concurrently. For example, the network element 305 may process the mapping table and determine to switch the implementation (e.g., switch models, switch parameters) or fall back to a different implementation for the positioning task depending upon the resources available at the network element to perform the positioning task relative to the required resource allocation for the different implementations for performing the positioning task. In some cases, triggering of modification to computational resources for artificial intelligence positioning may be internal to the network element 305.

By way of example, if configured accordingly, the network element 305 may switch from the more computationally heavy one-step artificial intelligence positioning to two-step positioning, thereby allowing for resource balance between artificial-intelligence-based positioning and other artificial-intelligence-related tasks (e.g., CSI feedback for massive MIMO, beam feedback).

In some cases, the network element 305 may be configured to cease artificial intelligence positioning and transition instead to a non-artificial-intelligence positioning implementation (e.g., DL-TDoA) in order to further conserve resources. The network element 305 may then update the artificial-intelligence-related functionalities running in parallel at the network element 305. That is, the network element 305 may perform selection, activation, deactivation, switching or fallback of artificial intelligence implementations at the network clement 305, which may include implementations performing tasks such as CSI feedback and beam management.

At 355, once the operation of the network element 305 converges to a stable state, the network element 305 may indicate one or more selected mappings (e.g., to the RAN node 310, to the network node, e.g., the LCM entity 115), such as by indicating the implementation that has been selected and is executing for each task. In some cases, the network element may indicate the computational resources allocated for each implementation including for each artificial-intelligence-related implementation (e.g., positioning, CSI feedback, beam management). In some cases, the network element 305 may report an achieved quality of service (QOS) for each implementation including each artificial-intelligence-related functionality. Additionally, or alternatively, the network element 305 may report a part of (e.g., one or more fields of) the mapping table configured (e.g., received) at 320, which was used to reach to the updated set of implementations including those that are artificial-intelligence-related implementations.

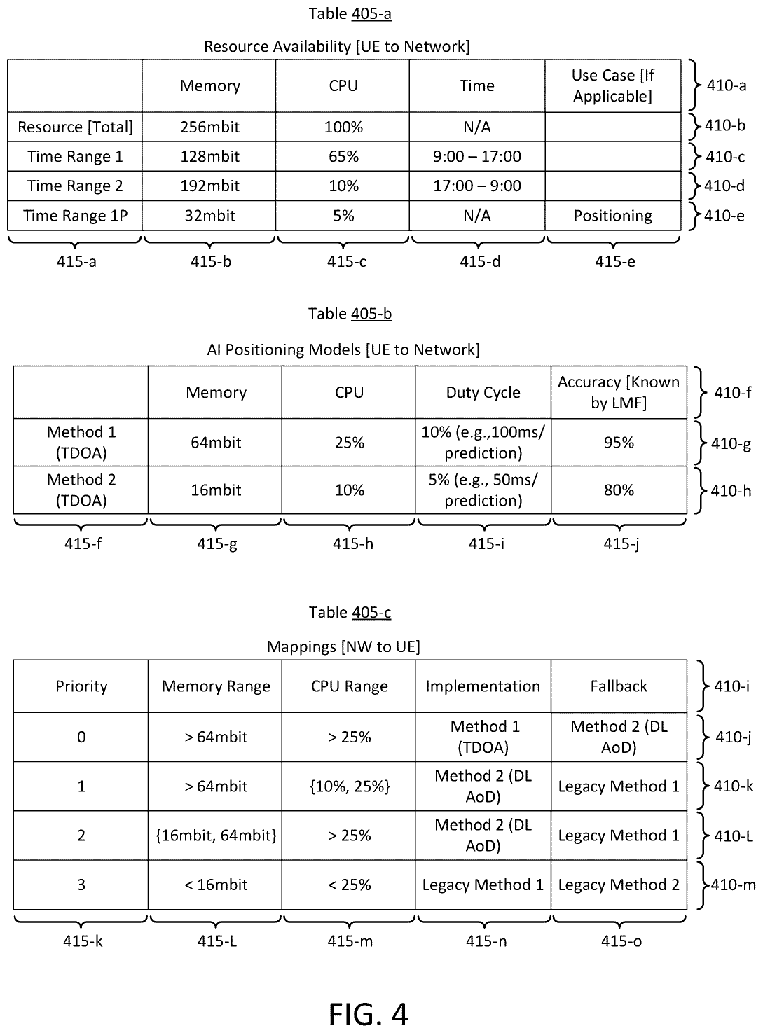

FIG. 4 illustrates examples of tables 405, which may be utilized or otherwise stored by a communication device such as a network element 305, e.g., a UE or a base station of the RAN, following provision by a network node 115 of the core network, as described with reference to FIG. 3. Information stored in one or more of the tables 405 may be utilized for selecting an implementation for performing one or more tasks, as described herein. Although the tables 405 described with reference to FIG. 4 include information relating to positioning of a communication device, one or more tables 405 may be utilized to store information related to any type of task. Additionally, it should be noted that the tables 405 described herein provide one illustrative example of a data structure for a mapping that may be utilized to organize and store information. However, other data structures may be utilized for performing the techniques described herein.

The table 405-a may include resource availability information (e.g., for a UE 105),

which may be provided to the network node. The table 405-a may include a plurality of rows 410 (e.g., a row 410-a, a row 410-b, a row 410-c, a row 410-d, and a row 410-c) and a plurality of columns 415 (e.g., a column 415-a, a column 415-b, a column 415-c, a column 415-d, and a column 415-c). The table 405-a may include multiple information elements, which may be identified by or otherwise correspond to respective rows 410 and columns 415. The column 415-a may include headings or information identifying respective rows 410. The row 410-a may include headings or information identifying respective columns 415. The column 415-b may include respective percentages or absolute quantities of available memory for a UE 105, the column 415-c may include respective percentages or absolute quantities of CPU processing power available at the UE 105, the column 415-d may include respective periods of time (e.g., time windows) when indicated information (e.g., memory, CPU power) is valid, and the column 415-c may include respective use cases (e.g., respective task types). As an illustrative example, information included in the row 410-c of the table 405-a may indicate that for the given time range (e.g., 9:00 to 17:00), a UE 105 has or is expected to have 128 megabits (mbits) of memory and 65% of a total CPU processing power available. Additionally, the row 410-a may include total resource quantities for a UE 105 (e.g., a total quantity of memory for the UE 105 may be 256 mbits).

The table 405-b may be information for various artificial intelligence models (e.g., utilized by the UE 105), which may be provided to the network node. The table 405-b may include a plurality of rows 410 (e.g., a row 410-f, a row 410-g, and a row 410-h) and a plurality of columns 415 (e.g., a column 415-f, a column 415-g, a column 415-h, a column 415-i, and a column 415-j). The table 405-b may include multiple information elements, which may be identified by or otherwise correspond to respective rows 410 and columns 415. The column 415-f may include headings or information identifying respective rows 410. The row 410-a may include headings or information identifying various implementations or methods utilized by a UE 105. For example, a UE 105 may perform a first implementation (e.g., a first TDOA implementation) or a second implementation (e.g., a second TDOA implementation). In some cases, the various implementations or methods may be associated with respective memory usages, CPU usages, duty cycles, and accuracies, which may be indicated by the column 415-g, the column 415-h, the column 415-i, and the column 415-j, respectively. As an illustrative example, and as indicated by the row 410-g, a UE 105 may perform a positioning task using a first implementation (e.g., a first TDOA method) that utilizes 64 mbits of memory, 25% of a total CPU power for the UE 105, has a 10% duty cycle, and has a 95% accuracy.

The table 405-c may include mapping information, which may be provided to the UE 105 by the network node. The mapping information may associate respective implementations (e.g., methods) for performing one or more respective tasks with respective resource conditions (e.g., required resource allocations) of the UE 105. The mapping information may also include respective priorities and respective fallback implementations that correspond to respective implementations and resource conditions.

The table 405-c may include a plurality of rows 410 (e.g., a row 410-i, a row 410-j, a row 410-k, a row 410-L, and a row 410-m) and a plurality of columns 415 (e.g., a column 415-k, a column 415-L, a column 415-m, a column 415-n, and a column 415-o). The table 405-c may include multiple information elements, which may be identified by or otherwise correspond to respective rows 410 and columns 415. The row 410-i may include headings or information identifying respective columns 415. The column 415-k may include priorities for respective implementations (e.g., with ‘0’ being the highest priority), the column 415-L may include memory ranges for respective implementations, the column 415-m may include CPU ranges for respective implementations, the column 415-n may include the respective implementations (e.g., primary implementations), and the column 415-o may include fallback implementations for respective implementations. As an illustrative example, information included in the row 410-j of the table 405-c may indicate that a first implementation (e.g., TDOA method 1) should be utilized by a UE 105 to perform one or more given tasks if the UE 105 has greater than 64 mbits of memory and greater than 25% of total CPU power available. The information include in the row 410-j may also indicate that the UE 105 should fall back to a second implementation (e.g., DL AoD method 2) if one or more current resource availability conditions fail to satisfy respective thresholds (e.g., if currently available memory is less than 64 mbits, or if currently available CPU power is less than 25%).

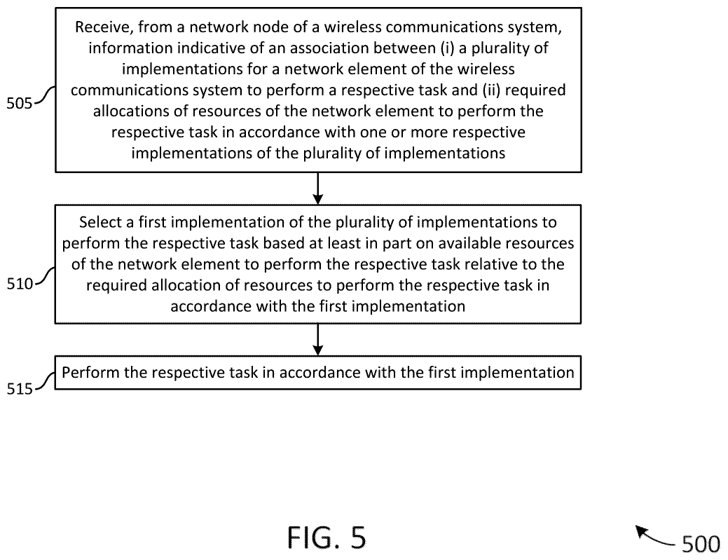

FIG. 5 illustrates an example of a flowchart 500 of the operations performed by an apparatus, such as may be embodied by a network element 305, a UE 105, a base station of the RAN or the like, as described with reference to FIGS. 1 and 3. As shown in block 505, the apparatus may include means, such as the processing circuitry 205, the communication interface 215 or the like, for receiving, from a network node, e.g., an LCM entity 115, information indicative of an association between (i) a plurality of implementations for a network element of a wireless communications system to perform a respective task and (ii) required allocations of resources for the network element to perform the respective task in accordance with one or more respective implementations of the plurality of implementations.

In some cases, the plurality of implementations correspond to one or more of: one or more implementations for the apparatus associated with respective artificial intelligence or machine learning enabled features or feature groups, one or more implementations for the apparatus associated with respective artificial intelligence or machine learning enabled functionalities, or one or more implementation variants for the apparatus associated with a given artificial intelligence or machine learning enabled functionality.

In some cases, the plurality of implementations include one or more implementations for performing the respective task relying on artificial intelligence or machine learning. In some cases, the plurality of implementations include one or more implementations for performing the respective task that do not rely on artificial intelligence or machine learning. In some cases, selecting the first implementation out of the plurality of implementations is based at least in part on priorities associated with respective implementations of the plurality of implementations.

As shown in block 510, the apparatus may include means, such as the processing circuitry 205 or the like, for selecting a first implementation of the plurality of implementations to perform the respective task based at least in part on available resources for the network clement to perform the respective task relative to the required allocation of resources to perform the respective task in accordance with the first implementation.

As shown in block 515, the apparatus further includes means, such as the processing circuitry 205 or the like, for performing the respective task in accordance with the first implementation.

The apparatus may also include means for causing transmission, to the network node, of resource availability information, where the plurality of implementations are based at least in part on the resource availability information. In some cases, two or more implementations of the plurality of implementations are associated with different types of artificial intelligence or machine learning models. In some cases, the resource availability information includes one or more of: availability information of processing resources of the apparatus, availability information of memory resources of the apparatus, battery life information of the apparatus, availability information of one or more inputs to use for performing the respective task, availability information of one or more outputs to use for the respective task, a connection status of the apparatus with the wireless communications system, or a connection quality of the apparatus with the wireless communications system. In some cases, the resource availability information may include, in addition to other examples of resource availability information described herein (e.g., physical resources at the network element for performing the task), availability information for resources that are allocated by another network entity to the network entity performing the respective task. As an example, if the network entity is a device performing a positioning task, the resource availability information may include a quantity of positioning reference signals and/or a quantity of transmission/reception points that are detected at the network entity. In such cases, “detection” may occur if received power for positioning reference signals from transmission/reception points satisfies (e.g., is above) a specified threshold. The threshold may be specified for time and frequency resources allocated to the detected positioning reference signals.

In some cases, the resource availability information indicates whether the resource availability information is dynamic or static. In some cases, the level of dynamic resource availability can involve multiple levels of dynamicity, such that the availability of resources can range from being fully static (i.e., no dynamicity) to being fully dynamic (i.e., to vary in the lowest level of time unit), or any dynamicity level in between. In some instances, the dynamic resource availability information may be valid for a limited time duration. In some cases, the resource availability information is indicative of one or more of a geographic area in which one or more resources of the apparatus are available, and outside of which the one or more resources of the apparatus are unavailable, or a period of time during which the one or more resources of the apparatus are available, and outside of which the one or more resources of the apparatus are unavailable.

In some cases, the resource availability information is indicative of one of: a percentage of resources that are available with respect to a total quantity of respective resources of the apparatus, a percentage of resources that are available with respect to a threshold quantity of the respective resources of the apparatus, or an absolute quantity of resources that are available. With respect to available memory, for example, the resource availability information of one embodiment may indicate that a certain percentage, e.g., 20%, of the total memory capacity is available, while, in another embodiment, the resource availability information may indicate that 5 gigabytes (GB) of memory are available.

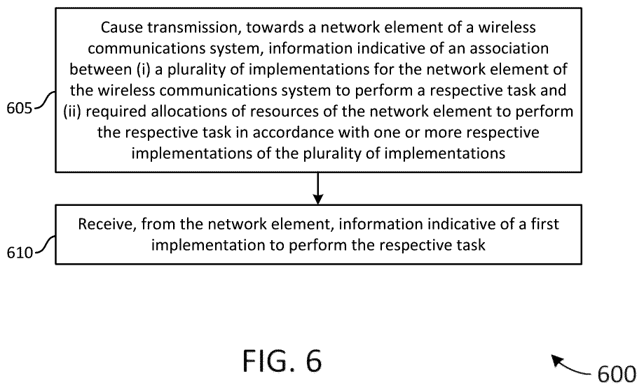

FIG. 6 illustrates an example of a flowchart 600 of the operations performed by an apparatus, such as may be embodied by a network node, e.g., an LCM entity 115, as described with reference to FIGS. 1 and 3. As shown in block 605, the apparatus may include means, such as the processing circuitry 205, the communication interface 215 or the like, for causing transmission, towards a network clement of a wireless communications system, information indicative of an association between (i) a plurality of implementations for the network element of the wireless communications system to perform a respective task and (ii) required allocations of resources for the network element to perform the respective task in accordance with one or more respective implementations of the plurality of implementations.

In some cases, the plurality of implementations correspond to one or more of: one or more implementations for the network element associated with respective artificial intelligence or machine learning enabled features or feature groups, one or more implementations for the network element associated with respective artificial intelligence or machine learning enabled functionalities, or one or more implementation variants for the network element associated with a given artificial intelligence or machine learning enabled functionality.

In some cases, the plurality of implementations include one or more implementations for the network element to perform the respective task relying on artificial intelligence or machine learning. In some cases, the plurality of implementations include one or more implementations for the network element to perform the respective task that do not rely on artificial intelligence or machine learning. In some cases, respective implementations out of the plurality of implementations are assigned respective priorities.

As shown in block 610, the apparatus may include means, such as the processing circuitry 205, the communication interface 215 or the like, for receiving, from the network clement, information indicative of a first implementation to perform the respective task.

In some cases, the apparatus may also include means for receiving, from the network clement, resource availability information for the network element, where the plurality of implementations are based at least in part on the resource availability information. In some cases, two or more implementations of the plurality of implementations are associated with different types of artificial intelligence or machine learning models. In some cases, the resource availability information includes one or more of: availability information of processing resources for the network element, availability information of memory resources for the network element, battery life information of the network element, availability information of one or more inputs of the network clement, availability information of one or more outputs of the network element, a connection status of the network element with the wireless communications system, or a connection quality of the network element with the wireless communications system. In some cases, the resource availability information may include, in addition to other examples of resource availability information described herein (e.g., physical resources at the network clement for performing the task), availability information for resources that are allocated by another network entity to the network entity performing the respective task. As an example, if the network entity is a device performing a positioning task, the resource availability information may include a quantity of positioning reference signals and/or a quantity of transmission/reception points that are detected at the network entity. In such cases, “detection” may occur if received power for positioning reference signals from transmission/reception points satisfies (e.g., is above) a specified threshold. The threshold may be specified for time and frequency resources allocated to the detected positioning reference signals.

In some cases, the resource availability information indicates whether the resource availability information is dynamic or static. In some cases, the level of dynamic resource availability can involve multiple levels of dynamicity, such that the availability of resources can range from being fully static (i.e., no dynamicity) to being fully dynamic (i.e., to vary in the lowest level of time unit), or any dynamicity level in between. In some embodiments, the dynamic resource availability information is valid for a limited time duration. In some cases, the resource availability information is indicative of one or more of: a geographic area in which one or more resources for the network element are available, and outside of which the one or more resources for the network element are unavailable, or a period of time during which the one or more resources for the network element are available, and outside of which the one or more resources for the network element are unavailable.

In some cases, the resource availability information is indicative of one of: a percentage of resources that are available with respect to a total quantity of respective resources for the network element, a percentage of resources that are available with respect to a threshold quantity of the respective resources for the network element, or an absolute quantity of resources that are available.

As described above, the network element 305 may be configured to select a particular implementation of a task based on the current condition of the network element and the information provided by the network node that is indicative of an association between (i) a plurality of implementations for the network element to perform the task and (ii) required allocations of resources for the network element to perform the task in accordance with one or more respective implementations of the plurality of implementations. As such, the resource utilization and performance of the network element may be enhanced by the selection of an implementation, such as an artificial-intelligence-enabled implementation, that is consistent with the resources available to the network element.

FIGS. 3, 5 and 6 illustrate flowcharts and signal flow diagrams depicting methods according to an example embodiment. It will be understood that each block or signal and combination of blocks and signals may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by the memory 210 of an apparatus employing an example embodiment and executed by processing circuitry 205. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1.-92. (canceled)

93. An apparatus comprising:
at least one processor; and
at least one memory storing instructions that, when executed by the at least one processor, cause the apparatus at least to perform:
receive, from a network node of a wireless communications system, information indicative of an association between (i) a plurality of implementations for a network element of the wireless communications system to perform a respective task and (ii) required allocations of resources for the network element to perform the respective task in accordance with one or more respective implementations of the plurality of implementations;
select a first implementation of the plurality of implementations to perform the respective task based at least in part on available resources for the network element to perform the respective task relative to the required allocation of resources to perform the respective task in accordance with the first implementation; and
perform the respective task in accordance with the first implementation.

94. The apparatus according to claim 93, wherein the instructions, when executed by the at least one processor, further cause the apparatus to at least:
cause transmission, to the network node, of information indicative of the first implementation selected to perform the respective task.

95. The apparatus according to claim 93, wherein the plurality of implementations correspond to one or more of:
one or more implementations for the network element associated with respective artificial intelligence or machine learning enabled features or feature groups;
one or more implementations for the network element associated with respective artificial intelligence or machine learning enabled functionalities; or
one or more implementation variants for the network element associated with a given artificial intelligence or machine learning enabled functionality.

96. The apparatus according to claim 93, wherein the plurality of implementations comprise one or more implementations for performing the respective task relying on artificial intelligence or machine learning.

97. The apparatus according to claim 96, wherein two or more implementations of the plurality of implementations are associated with different types of artificial intelligence or machine learning models.

98. The apparatus according to claim 93, wherein the plurality of implementations comprise one or more implementations for performing the respective task that do not rely on artificial intelligence or machine learning.

99. The apparatus according to claim 93, wherein selecting the first implementation out of the plurality of implementations is based at least in part on priorities associated with respective implementations of the plurality of implementations.

100. The apparatus according to claim 93, wherein the instructions, when executed by the at least one processor, further cause the apparatus to at least:
cause transmission, to the network node, of resource availability information, wherein the plurality of implementations are based at least in part on the resource availability information.

101. The apparatus according to claim 100, wherein the resource availability information comprises one or more of:
availability information of processing resources for the network element;
availability information of memory resources for the network element;
battery life information of the network element;
availability information of one or more inputs to use for performing the respective task;
availability information of one or more outputs to use for the respective task;
a connection status of the network element with the wireless communications system;
a connection quality of the network element with the wireless communications system; or
availability information of one or more communication resources for the network element.

102. The apparatus according to claim 100, wherein the resource availability information indicates whether the resource availability information is dynamic or static, wherein dynamic resource availability information is valid for a limited time duration.

103. The apparatus according to claim 100, wherein the resource availability information is indicative of one or more of:
a geographic area in which one or more resources for the network element are available, and outside of which the one or more resources for the network element are unavailable; or a period of time during which the one or more resources for the network element are available, and outside of which the one or more resources for the network element are unavailable.

104. The apparatus according to claim 100, wherein the resource availability information is indicative of one of:
a percentage of resources that are available with respect to a total quantity of respective resources for the network element;
a percentage of resources that are available with respect to a threshold quantity of the respective resources for the network element; or
an absolute quantity of resources that are available.

105. An apparatus comprising:
at least one processor; and
at least one memory storing instructions that, when executed by the at least one processor, cause the apparatus at least to perform:
cause transmission, towards a network element of a wireless communications system, information indicative of an association between (i) a plurality of implementations for the network element of the wireless communications system to perform a respective task and (ii) required allocations of resources for the network element to perform the respective task in accordance with one or more respective implementations of the plurality of implementations; and
receive, from the network element, information indicative of a first implementation to perform the respective task.

106. The apparatus according to claim 105, wherein the plurality of implementations correspond to one or more of:
one or more implementations for the network element associated with respective artificial intelligence or machine learning enabled features or feature groups;
one or more implementations for the network element associated with respective artificial intelligence or machine learning enabled functionalities; or
one or more implementation variants for the network element associated with a given artificial intelligence or machine learning enabled functionality.

107. The apparatus according to claim 105, wherein the plurality of implementations comprise one or more implementations for the network element to perform the respective task relying on artificial intelligence or machine learning.

108. The apparatus according to claim 107, wherein two or more implementations of the plurality of implementations are associated with different types of artificial intelligence or machine learning models.

109. The apparatus according to claim 105, wherein the plurality of implementations comprise one or more implementations for the network element to perform the respective task that do not rely on artificial intelligence or machine learning.

110. The apparatus according to claim 105, wherein respective implementations out of the plurality of implementations are assigned respective priorities.

111. The apparatus according to claim 105, wherein the instructions, when executed by the at least one processor, further cause the apparatus to at least:
receive, from the network element, resource availability information for the network element, wherein the plurality of implementations are based at least in part on the resource availability information.

112. An apparatus comprising:
means for receiving, from a network node of a wireless communications system, information indicative of an association between (i) a plurality of implementations for a network element of the wireless communications system to perform a respective task and (ii) required allocations of resources for the network element to perform the respective task in accordance with one or more respective implementations of the plurality of implementations;
means for selecting a first implementation of the plurality of implementations to perform the respective task based at least in part on available resources for the network element to perform the respective task relative to the required allocation of resources to perform the respective task in accordance with the first implementation; and
means for performing the respective task in accordance with the first implementation.
